(19) United States
(12) Patent Application Publication
(10) Pub. No.: US 2017/0139603 A1
(43) Pub. Date: May 18, 2017

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 15/096,691

(22) Filed: Apr. 12, 2016

(30) Foreign Application Priority Data
Nov. 13, 2015 (KR) 10-2015-0159586

(51) Int. Cl. G06F 3/06; G06F 12/10; G06F 12/02

(52) U.S. Cl. CPC G06F 3/0605; G06F 3/0626; G06F 3/064; G06F 3/0644; G06F 3/0659; G06F 3/0665; G06F 3/0673; G06F 12/0253; G06F 12/1009; G06F 2212/1056; G06F 2212/152; G06F 2212/651; G06F 2212/657; G06F 2212/69

(57) ABSTRACT

A memory system may include: a plurality of memory blocks each including a plurality of page zones each page zone including a plurality of pages suitable for storing data; and a controller suitable for updating one or more closed memory blocks, by storing data into another memory block among the memory blocks in response to a write command for the one or more closed memory blocks, and updating a map list indicating one or more invalid page zones each of which contains only invalid pages in the closed memory blocks, as a result of the updating of the closed memory blocks.

### CROSS-REFERENCE TO RELATED APPLICATIONS

The present application claims priority of Korean Patent Application No. 10-2015-0159586, filed on Nov. 13, 2015 in the Korean Intellectual Property Office, the disclosure of which is incorporated herein by reference in its entirety.

### BACKGROUND

1. Field

Exemplary embodiments of the present invention relate generally to a memory system and, more particularly, to a memory system processing data to a memory device and an operating method thereof.

2. Description of the Related Art

The computer environment paradigm has shifted to ubiquitous computing systems that can be used anywhere and at any time. Due to this fact, the use of portable electronic devices, such as mobile phones, digital cameras, and notebook computers has rapidly increased.

These portable electronic devices generally use a memory system having one or more memory devices for storing data, that is, a data storage device. A data storage device may be used as a main or an auxiliary memory device of a portable electronic device.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

### SUMMARY

Various embodiments of the present invention are directed to a memory system which is capable of minimizing the complexity and performance degradation of the memory system, and maximizing the use efficiency of a memory device, thereby rapidly and stably processing data, and an operating method thereof.

In an embodiment, a memory system may include: a plurality of memory blocks each including a plurality of page zones each page zone including a plurality of pages suitable for storing data; and a controller suitable for updating one or more closed memory blocks, by storing data into another memory block among the memory blocks in response to a write command for the one or more closed memory blocks, and updating a map list indicating one or more invalid page zones each of which contains only invalid pages in the closed memory blocks, as a result of the updating of the closed memory blocks.

The map list may include a plurality of bit regions corresponding to the page zones of the memory blocks, respectively.

The controller may set the bit regions to a value representing the invalid segment as the result of the updating of the closed memory blocks.

The controller may further generate an empty memory block by detecting and collecting the invalid page zones.

The controller may generate the empty memory block with the invalid page zones based on the set value of the bit regions.

The controller may further perform an garbage collection to the other page zones other than the invalid page zones in the closed memory blocks.

The map list may be in the form of bitmap, clean map, or clean block bitmap.

In an embodiment, an operating method of a memory system including a plurality of memory blocks each including a plurality of page zones each including a plurality of pages suitable for storing data, the operating method may include: updating one or more closed memory blocks, which are full of programmed data, by storing data into another memory block among the memory blocks in response to a write command for the closed memory blocks; and updating a map list indicating one or more invalid page zones, each of which is full of invalid pages in the closed memory blocks, as a result of the updating of the closed memory blocks.

The map list may include a plurality of bit regions corresponding to the page zones of the memory blocks, respectively.

The updating of the map list may include setting the bit regions to a value representing the invalid segment as the result of the updating of the closed memory blocks.

The operating method may further include generating an empty memory block with the invalid page zones.

The generating of the empty memory block may be performed on the basis of the set value of the bit regions.

The operating method may further include performing a garbage collection to the other page zones other than the invalid page zones in the closed memory blocks.

The map list may be in the form of bitmap, clean map, or clean block bitmap.

In an embodiment, a memory system may include: a plurality of memory blocks each including a plurality of page zones each page zone including a plurality of pages suitable for storing data; and a controller suitable for detecting page zones having only invalid pages from a plurality of page zones of a plurality of closed memory blocks, and for collecting the detected invalid page zones to generate a first empty memory block before performing a garbage collection operation for reclaiming invalid pages of page zones having both valid and invalid pages.

The controller may be performing a garbage collection operation to create one or more additional empty memory blocks on either an entire memory block comprising only page zones having both valid and invalid pages or on a page zone having both valid and invalid pages, after the generation of the first empty memory block.

### BRIEF DESCRIPTION OF THE DRAWINGS

FIG. 1 is a diagram illustrating a data processing system including a memory system, according to an embodiment of the present invention.

FIG. 2 is a diagram illustrating more detail of an example of a memory device of the memory system shown in FIG. 1.

FIG. 3 is a circuit diagram illustrating a memory block of a memory device, according to an embodiment of the present invention.

FIGS. 4 to 11 are diagrams schematically illustrating further structural details of the memory device of FIG. 2, according to embodiments of the present invention.

FIG. 12 is a diagram schematically illustrating a data processing operation, according to an embodiment of the present invention.

FIG. 13 is a flowchart of a data processing operation, according to an embodiment of the present invention.

### DETAILED DESCRIPTION

Various embodiments of the invention will be described below in more detail with reference to the accompanying drawings. The present invention may, however, be embodied in different forms and should not be construed as being limited to the embodiments set forth herein. Rather, these embodiments are provided so that this disclosure will be thorough and complete, and will fully convey the invention to those skilled in the relevant art. Throughout the disclosure, like reference numerals refer to like parts throughout the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically stated otherwise. It should be readily understood that the meaning of “on” and “over” in the present disclosure should be interpreted in the broadest manner such that “on” means not only “directly on” but also “on” something with an intermediate feature(s) or a layer(s) therebetween, and that “over” means not only directly on top but also on top of something with an intermediate feature(s) or a layer(s) therebetween. When a first layer is referred to as being “on” a second layer or “on” a substrate, it may not only refer to a case where the first layer is formed directly on the second layer or the substrate but may also refer to a case where a third layer exists between the first and the second layers or the substrate.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be further understood that the terms “comprises”, “comprising”, “Includes”, “including,” “has,” or “having” when used in this specification, specify the presence of the stated features, integers, operations, elements, and/or components, but do not preclude the presence or addition of one or more other features, integers, operations, elements, components, and/or combinations thereof. As used herein, the term “and/or” includes any and all combinations of one or more of the associated listed items.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Hereinafter, the various embodiments of the present disclosure will be described in more detail with reference to the drawings.

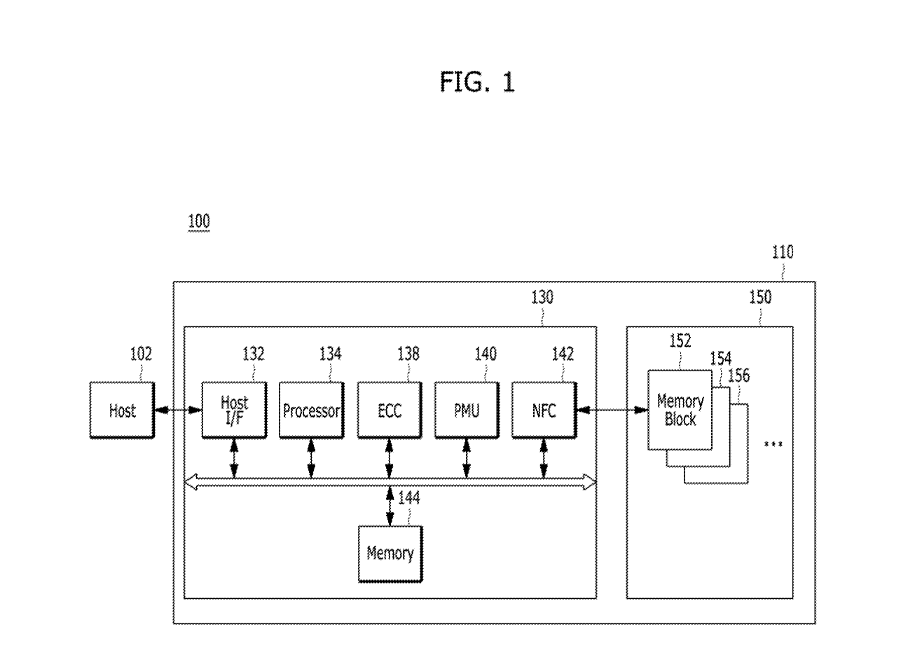

FIG. 1 is a block diagram illustrating a data processing system including a memory system, according to an embodiment of the invention.

Referring to FIG. 1, a data processing system 100 may include a host 102 and a memory system 110.

The host 102 may be or include, for example, a portable electronic device, such as a mobile phone, an MP3 player and a laptop computer and the like. The host 102 may be or include, also for example, an electronic device, such as a desktop computer, a game player, a TV, a projector and the like.

The memory system 110 may operate in response to a request from the host 102. For example, the memory system 110 may store data to be accessed by the host 102. The memory system 110 may be used as a main memory system of the host 102. The memory system 110 may be used as an auxiliary memory system of the host 102. The memory system 110 may be or include any one of various kinds of data storage devices, according to the protocol of a host interface which may be coupled electrically with the host 102. The memory system 110 may be or include any one of various kinds of storage devices, such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device, such as a dynamic random access memory (DRAM) and a static random access memory (SRAM).

The storage devices for the memory system 110 may be implemented with a nonvolatile memory device, such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), a resistive RAM (RRAM) and the like.

The memory system 110 may include a memory device 150 for storing data to be accessed by the host 102, and a controller 130 for controlling data storage in the memory device 150.

The controller 130 and the memory device 150 may be integrated into a single semiconductor device. For instance, the controller 130 and the memory device 150 may be integrated into a single semiconductor device configured as a solid state drive (SSD). When the memory system 110 is implemented as a SSD, the operation speed of the host 102 may be significantly increased.

The controller 130 and the memory device 150 may be integrated into a single semiconductor device configured as a memory card. The controller 130 and the memory card 150 may be integrated into a single semiconductor device configured as a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, a universal flash storage (UFS) device and the like.

For another instance, the memory system 110 may be or include a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, one of various component elements configuring a computing system and the like.

The memory device 150 may store data provided from the host 102 during a write operation. The memory device may provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) may be coupled electrically.

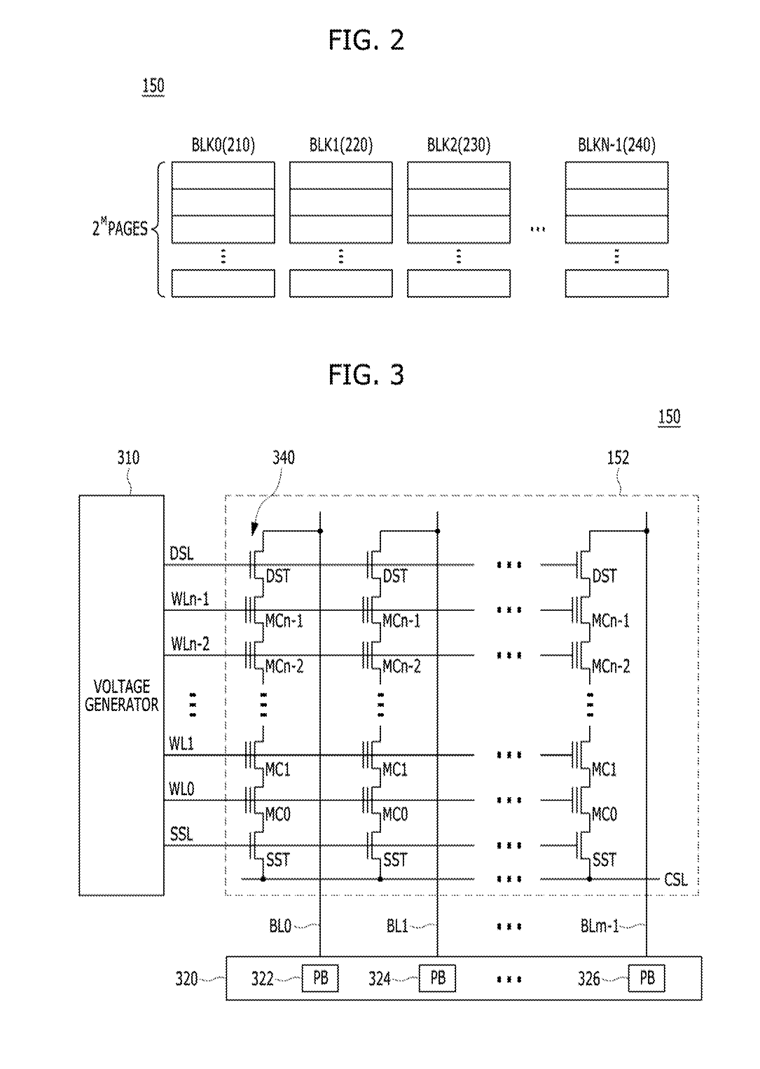

The memory device 150 may retain stored data when power supply is interrupted or turned off. The memory device 150 may be a nonvolatile memory device, for example, a flash memory. The flash memory may have a three-dimensional (3D) stack structure. A 3D stack structure of a memory device 150 will be described later in more detail with reference to FIGS. 2 to 11.

The controller 130 may control the memory device 150 in response to a request from the host 102. The controller 130 may control the flow of data between the memory device 150 and the host 102. For example, the controller 130 may provide data read from the memory device 150 to the host 102, and store data provided from the host 102 into the memory device 150. To this end, the controller 130 may control the overall operations of the memory device 150, such as, for example, read, write, program and erase operations.

In the example of FIG. 1, the controller 130 may include a host interface unit 132, a processor 134, an error correction code (ECC) unit 138, a power management unit 140, a NAND flash controller 142, and a memory 144.

The host interface unit 132 may process commands and data provided from the host 102. The host interface unit 132 may communicate with the host 102 through at least one of various interface protocols, such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), integrated drive electronics (IDE) and the like.

The ECC unit 138 may detect and correct errors in the data read from the memory device 150 during a read operation. For example, the ECC unit 138 may not correct error bits when the number of the error bits is greater than or equal to a threshold number of correctable error bits, and may output an error correction fail signal indicating failure in correcting the error bits.

The ECC unit 138 may perform an error correction operation based on a coded modulation, such as a low density parity check (LDPC) code, a Bose-Chaudhurl-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC unit 138 may include all circuits, systems or devices as may be needed for the error correction operation.

The PMU 140 may provide and or manage power for the controller 130, that is, power for the component elements included in the controller 130. Any suitable power module may be used.

The NFC 142 may serve as a memory interface between the controller 130 and the memory device 150 for allowing the controller 130 to control the memory device 150, for example, in response to a request from the host 102. The NFC 142 may generate control signals for the memory device 150 and process data under the control of the processor 134 when the memory device 150 is a flash memory and, for example, when the memory device 150 is a NAND flash memory.

Although the Interface unit 142 in the embodiment of FIG. 1 is an NFC unit suitable for interfacing the NAND flash memory with the controller the invention is not limited in this way. The interface unit 142 may be any suitable interface unit suitable for interfacing the memory device 150 to the controller. It is noted that the specific architecture and functionality of the interface unit 142 may vary depending upon the type of the memory device employed.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be or include any suitable memory device. The memory 144 may be a volatile memory. The memory 144 may be or include a static random access memory (SRAM). The memory 144 may be or include a dynamic random access memory (DRAM). The memory 144 may include any suitable architecture. For example, the memory 144 may include a program memory, a data memory, a write buffer, a read buffer, a map buffer, and the like all of which are well known in the art.

The processor 134 may control general operations of the memory system 110. The processor 134 may control a write or a read operation for the memory device 150, in response to a write or a read request from the host 102. The processor 134 may be or comprise any suitable processor. The processor 134 may drive firmware, which is referred to as a flash translation layer (FTL), to control the general operations of the memory system 110. The processor 134 may be or include a microprocessor. Any suitable microprocessor may be used. The processor 134 may be or include or a central processing unit (CPU).

A bad block management unit (not shown) may be included in the processor 134, for performing bad block management of the memory device 150. The bad block management unit may find bad memory blocks included in the memory device 150, which are in unsatisfactory condition for further use, and perform bad block management on the bad memory blocks. When the memory device 150 is a flash memory, for example, a NAND flash memory, a program failure may occur during the write operation, for example, during the program operation, due to characteristics of a NAND logic function. During the bad block management operation, the data of the program-failed memory block or the bad memory block may be programmed into a new memory block. Bad blocks due to a program fall may seriously deteriorate the utilization efficiency of the memory device 150 and the reliability of the memory system 100. Thus, reliable bad block management may be included in the processor 134 for resolving these concerns.

FIG. 2 illustrates an example of a memory device 150 shown in FIG. 1.

Referring to FIG. 2, the memory device 150 may include a plurality of memory blocks, for example, zeroth to (N−1)^{th} blocks 210 to 240. Each of the plurality of memory blocks 210 to 240 may include a plurality of pages, for example, 2^{M} number of pages (2^{M} PAGES), to which the present invention will not be limited. Each of the plurality of pages may include a plurality of memory cells to which a plurality of word lines may be coupled electrically.

The memory blocks may be single level cell (SLC) memory blocks or multi-level cell (MLC) memory blocks, according to the number of bits which may be stored or expressed in each memory cell. An SLC memory block may include a plurality of pages including a plurality of memory cells, each memory cell being capable of storing 1-bit data. An MLC memory block may include a plurality of pages including a plurality of memory cells, each memory cell being capable of storing multi-bit data, for example, two or more-bit data. An MLC memory block including a plurality of pages which are implemented with memory cells that are each capable of storing 3-bit data may be defined as a triple level cell (TLC) memory block.

Each of the plurality of memory blocks 210 to 240 may store the data provided from the host device 102 during a write operation, and may provide stored data to the host 102 during a read operation.

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are coupled electrically to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be coupled electrically in series between the select transistors DST and SST. The respective memory cells MC0 to MCn−1 may be configured by multi-level cells (MLC) each of which stores data information of a plurality of bits. The strings 340 may be coupled electrically to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 according to with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 may provide word line voltages, for example, a program voltage, a read voltage and a pass voltage, to be supplied to respective word lines according to an operation mode and voltages to be supplied to bulks, for example, well regions in which the memory cells are formed. The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 may be controlled by the control circuit, and may serve as a sense amplifier or a write driver according to an operation mode. During a verification/normal read operation, the read/write circuit 320 may serve as a sense amplifier for reading data from the memory cell array. Also, during a program operation, the read/write circuit 320 may serve as a write driver which drives bit lines according to data to be stored in the memory cell array. The read/write circuit 320 may receive data to be written in the memory cell array, from a buffer (not shown), during the program operation, and may drive the bit lines according to the inputted data. To this end, the read/write circuit 320 may include a plurality of page buffers 322, 324 and 326 respectively corresponding to columns (or bit lines) or pairs of columns (or pairs of bit lines), and a plurality of latches (not shown) may be included in each of the page buffers 322, 324 and 326.

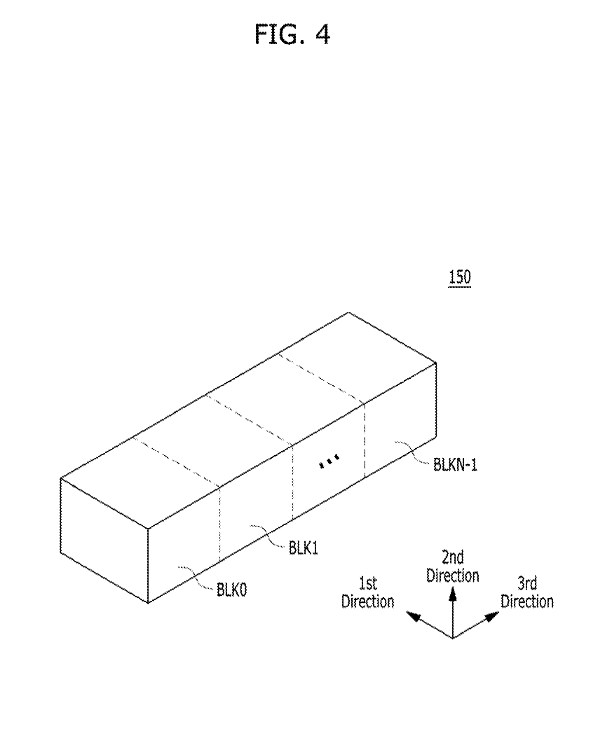

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN−1. Each of the memory blocks BLK0 to BLKN−1 may be realized in a three-dimensional (3D) structure or a vertical structure. The respective memory blocks BLK0 to BLKN−1 may include structures extending in first to third directions, for example, an x-axis, a y-axis, and a z-axis direction.

The respective memory blocks BLK0 to BLKN−1 may include a plurality of NAND strings NS extending in the second direction. The plurality of NAND strings NS may be provided in the first direction and the third direction. Each NAND string NS may be coupled electrically to a bit line BL, at least one source select line SSL, at least one ground select line GSL, a plurality of word lines WL, at least one dummy word line DWL, and a common source line CSL. Namely, the respective memory blocks BLK0 to BLKN−1 may be coupled electrically to a plurality of bit lines BL, a plurality of source select lines SSL, a plurality of ground select lines GSL, a plurality of word lines WL, a plurality of dummy word lines DWL, and a plurality of common source lines CSL.

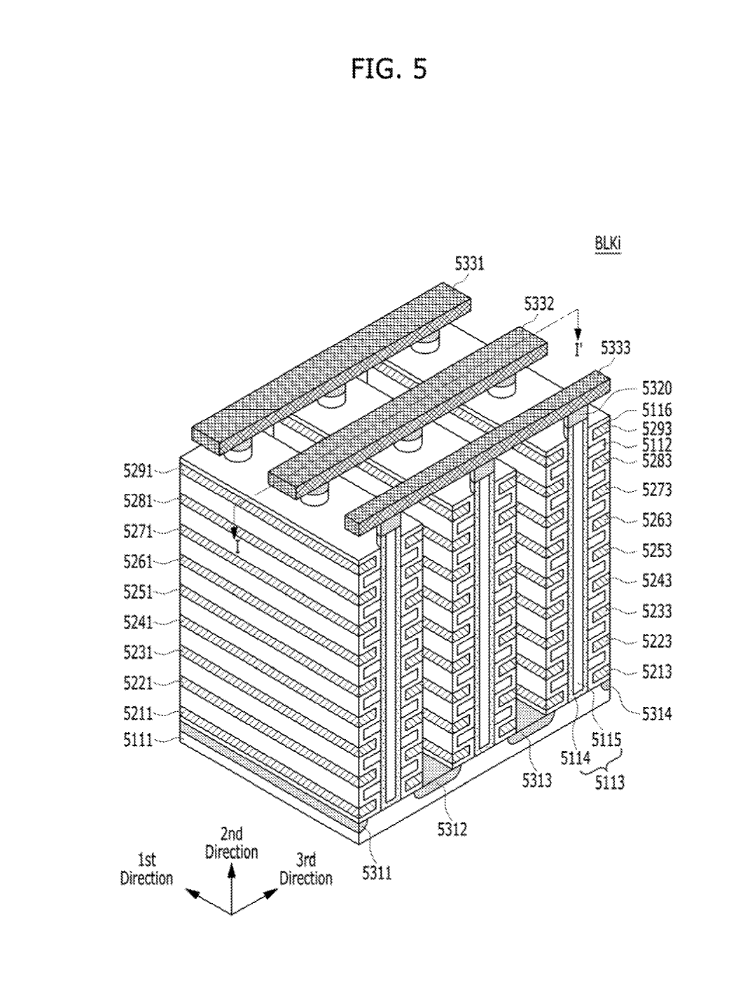

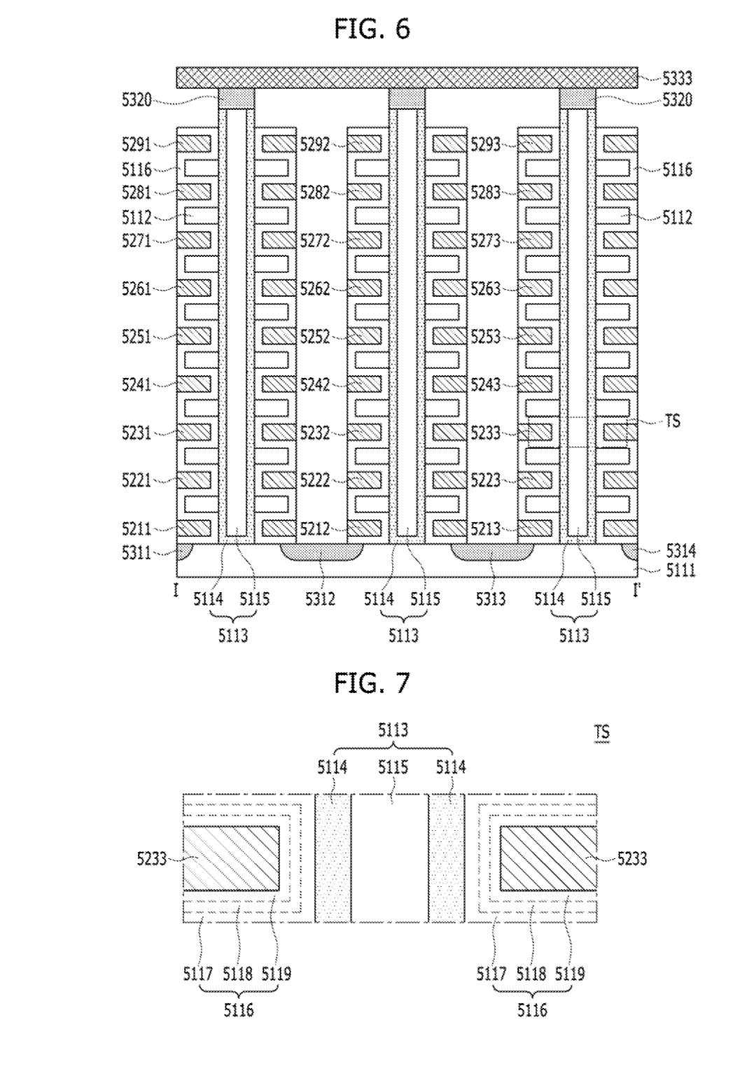

FIG. 5 is a perspective view of one BLKi of the plural memory blocks BLK0 to BLKN−1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure extending in the first to third directions.

A substrate 5111 may be provided. The substrate 5111 may include a silicon material doped with a first type impurity. The substrate 5111 may include a silicon material doped with a p-type impurity or may be a p-type well, for example, a pocket p-well, and include an n-type well which surrounds the p-type well. While it is assumed that the substrate 5111 is p-type silicon, it is to be noted that the substrate 5111 is not limited to being p-type silicon.

A plurality of doping regions 5311 to 5314 extending in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 extending in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be coupled electrically with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 extending in the first direction may be provided between the dielectric material 5112 adjacent to the substrate 5111 and the substrate 5111. For example, the conductive material 5211 extending in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material extending in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 extending in the first direction may be provided between the dielectric materials 5112. The conductive material 5291 extending in the first direction may be provided over the uppermost dielectric material 5112. The conductive materials 5211 to 5291 extending in the first direction may be a metallic material. The conductive materials 5211 to 5291 extending in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 extending in the first direction may be provided.

In the region between the third and fourth doping regions 5313 and 5314, the same structures as between the first and second doping regions 5311 and 5312 may be provided. For example, in the region between the third and fourth doping regions 5313 and 5314, the plurality of dielectric materials 5112 extending in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 extending in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed for the sake of convenience that the drains 5320 include n-type silicon, it is to be noted that the drains 5320 are not limited to being n-type silicon. For example, the width of each drain 5320 may be larger than the width of each corresponding pillar 5113. Each drain 5320 may be provided in the shape of a pad over the top surface of each corresponding pillar 5113.

Conductive materials 5331 to 5333 extending in the third direction may be provided over the drains 5320. The conductive materials 5331 to 5333 may be sequentially disposed in the first direction. The respective conductive materials 5331 to 5333 may be coupled electrically with the drains 5320 of corresponding regions. The drains 5320 and the conductive materials 5331 to 5333 extending in the third direction may be coupled electrically with through contact plugs. The conductive materials 5331 to 5333 extending in the third direction may be a metallic material. The conductive materials 5331 to 5333 extending in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 extending in the first direction. The respective pillars 5113 may form NAND strings NS together with the dielectric layer 5116 and the conductive materials 5211 to 5291, 5212 to 5292 and 5213 to 5293 extending in the first direction. Each NAND string NS may include a plurality of transistor structures TS.

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer and may include a nitride layer or a metal oxide layer, such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 extending in the first direction may be formed as a single layer or multiple layers. The third sub dielectric layer 5119 may be a high-k dielectric layer, such as an aluminum oxide layer, a hafnium oxide layer, or the like, having a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, for the sake of convenience, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS extending in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 extending in the first direction. In other words, the gates or the control gates may extend in the first direction and form word lines and at least two select lines, at least one source select line SSL and at least one ground select line GSL.

The conductive materials 5331 to 5333 extending in the third direction may be coupled electrically to one end of the NAND strings NS. The conductive materials 5331 to 5333 extending in the third direction may serve as bit lines BL. That is, in one memory block BLKi, the plurality of NAND strings NS may be coupled electrically to one-bit line BL.

The second type doping regions 5311 to 5314 extending in the first direction may be provided to the other ends of the NAND strings NS. The second type doping regions 5311 to 5314 extending in the first direction may serve as common source lines CSL.

Namely, the memory block BLKi may include a plurality of NAND strings NS extending in a direction perpendicular to the substrate 5111, and may serve as a NAND flash memory block, for example, of a charge capturing type memory, in which a plurality of NAND strings NS are coupled electrically to one-bit line BL.

While it is illustrated in FIGS. 5 to 7 that the conductive materials 5211 to 5291, 5212 to 5292 and 5213 to 5293 extending in the first direction are provided in 9 layers, it is to be noted that the conductive materials 5211 to 5291, 5212 to 5292 and 5213 to 5293 extending in the first direction are not limited to being provided in 9 layers. For example, conductive materials extending in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are coupled electrically to one-bit line BL, it is to be noted that the embodiment is not limited to having 3 NAND strings NS that are coupled electrically to one-bit line BL. In the memory block BLKi, m number of NAND strings NS may be coupled electrically to one-bit line BL, m being a positive integer. According to the number of NAND strings NS which are coupled electrically to one-bit line BL, the number of conductive materials 5211 to 5291, 5212 to 5292 and 5213 to 5293 extending in the first direction and the number of common source lines 5311 to 5314 may be controlled as well.

Further, while it is illustrated in FIGS. 5 to 7 that 3 NAND strings NS are coupled electrically to one conductive material extending in the first direction, it is to be noted that the embodiment is not limited to having 3 NAND strings NS coupled electrically to one conductive material extending in the first direction. For example, n number of NAND strings NS may be coupled electrically to one conductive material extending in the first direction, n being a positive integer. According to the number of NAND strings NS which are coupled electrically to one conductive material extending in the first direction, the number of bit lines 5331 to 5333 may be controlled as well.

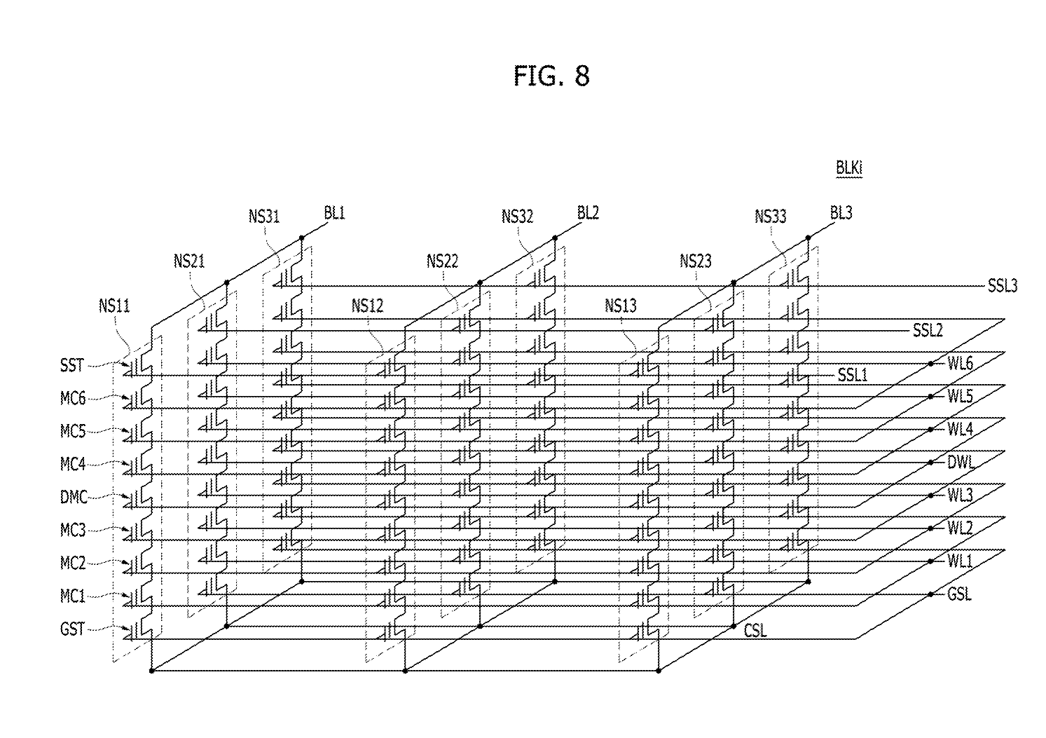

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, extending in the third direction. NAND strings NS12 to NS32 may be provided between a second bit line BL2 and the common source line CSL. The second bit line BL2 may correspond to the conductive material 5332 of FIGS. 5 and 6, extending in the third direction. NAND strings NS13 to NS33 may be provided between a third bit line BL3 and the common source line CSL. The third bit line BL3 may correspond to the conductive material 5333 of FIGS. 5 and 6, extending in the third direction.

A source select transistor SST of each NAND string NS may be coupled electrically to a corresponding bit line BL. A ground select transistor GST of each NAND string NS may be coupled electrically to the common source line CSL. Memory cells MC may be provided between the source select transistor SST and the ground select transistor GST of each NAND string NS.

In this example, NAND strings NS may be defined by units of rows and columns and NAND strings NS which are coupled electrically to one-bit line may form one column. The NAND strings NS11 to NS31 which are coupled electrically to the first bit line BL1 may correspond to a first column, the NAND strings NS12 to NS32 which are coupled electrically to the second bit line BL2 may correspond to a second column, and the NAND strings NS13 to NS33 which are coupled electrically to the third bit line BL3 may correspond to a third column. NAND strings NS which are coupled electrically to one source select line SSL may form one row. The NAND strings NS11 to NS13 which are coupled electrically to a first source select line SSL1 may form a first row, the NAND strings NS21 to NS23 which are coupled electrically to a second source select line SSL2 may form a second row, and the NAND strings NS31 to NS33 which are coupled electrically to a third source select line SSL3 may form a third row.

In each NAND string NS, a height may be defined. In each NAND string NS, the height of a memory cell MC1 adjacent to the ground select transistor GST may have a value ‘1’. In each NAND string NS, the height of a memory cell may increase as the memory cell gets closer to the source select transistor SST when measured from the substrate 5111. In each NAND string NS, the height of a memory cell MC6 adjacent to the source select transistor SST may be 7.

The source select transistors SST of the NAND strings NS in the same row may share the source select line SSL. The source select transistors SST of the NAND strings NS in different rows may be respectively coupled electrically to the different source select lines SSL1, SSL2 and SSL3.

The memory cells at the same height in the NAND strings NS in the same row may share a word line WL. That is, at the same height, the word lines WL coupled electrically to the memory cells MC of the NAND strings NS in different rows may be coupled electrically. Dummy memory cells DMC at the same height in the NAND strings NS of the same row may share a dummy word line DWL. Namely, at the same height or level, the dummy word lines DWL coupled electrically to the dummy memory cells DMC of the NAND strings NS in different rows may be coupled electrically.

The word lines WL or the dummy word lines DWL located at the same level or height or layer may be coupled electrically with one another at layers where the conductive materials 5211 to 5291, 5212 to 5292 and 5213 to 5293 extending in the first direction may be provided. The conductive materials 5211 to 5291, 5212 to 5292 and 5213 to 5293 extending in the first direction may be coupled electrically, in common, to upper layers through contacts. At the upper layers, the conductive materials 5211 to 5291, 5212 to 5292 and 5213 to 5293 extending in the first direction may be coupled electrically. In other words, the ground select transistors GST of the NAND strings NS in the same row may share the ground select line GSL. Further, the ground select transistors GST of the NAND strings NS in different rows may share the ground select line GSL. That is, the NAND strings NS11 to NS13, NS21 to NS23 and NS31 to NS33 may be coupled electrically to the ground select line GSL.

The common source line CSL may be coupled electrically to the NAND strings NS. Over the active regions and over the substrate 5111, the first to fourth doping regions 5311 to 5314 may be coupled electrically. The first to fourth doping regions 5311 to 5314 may be coupled electrically to an upper layer through contacts and, at the upper layer, the first to fourth doping regions 5311 to 5314 may be coupled electrically.

Namely, as shown in FIG. 8, the word lines WL of the same height or level may be coupled electrically. Accordingly, when a word line WL at a specific height is selected, all NAND strings NS which are coupled electrically to the word line WL may be selected. The NAND strings NS in different rows may be coupled electrically to different source select lines SSL. Accordingly, among the NAND strings NS coupled electrically to the same word line WL, by selecting one of the source select lines SSL1 to SSL3, the NAND strings NS in the unselected rows may be electrically isolated from the bit lines BL1 to BL3. In other words, by selecting one of the source select lines SSL1 to SSL3, a row of NAND strings NS may be selected. Moreover, by selecting one of the bit lines BL1 to BL3, the NAND strings NS in the selected rows may be selected in units of columns.

In each NAND string NS, a dummy memory cell DMC may be provided. In FIG. 8, the dummy memory cell DMC may be provided between a third memory cell MC3 and a fourth memory cell MC4 in each NAND string NS. That is, first to third memory cells MC1 to MC3 may be provided between the dummy memory cell DMC and the ground select transistor GST. Fourth to sixth memory cells MC4 to MC6 may be provided between the dummy memory cell DMC and the source select transistor SST. The memory cells MC of each NAND string NS may be divided into memory cell groups by the dummy memory cell DMC. In the divided memory cell groups, memory cells, for example, MC1 to MC3, adjacent to the ground select transistor GST may be referred to as a lower memory cell group, and memory cells, for example, MC4 to MC6, adjacent to the string select transistor SST may be referred to as an upper memory cell group.

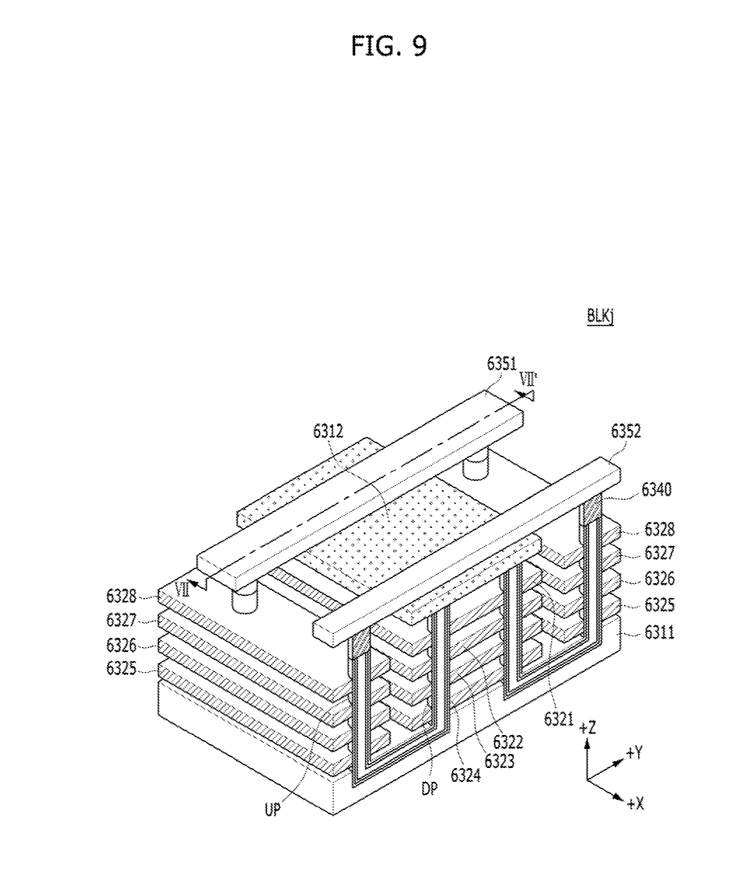

Hereinbelow, detailed descriptions will be made with reference to FIGS. 9 to 11, which show the memory device in the memory system according to an embodiment implemented with a 3D nonvolatile memory device different from the first structure.

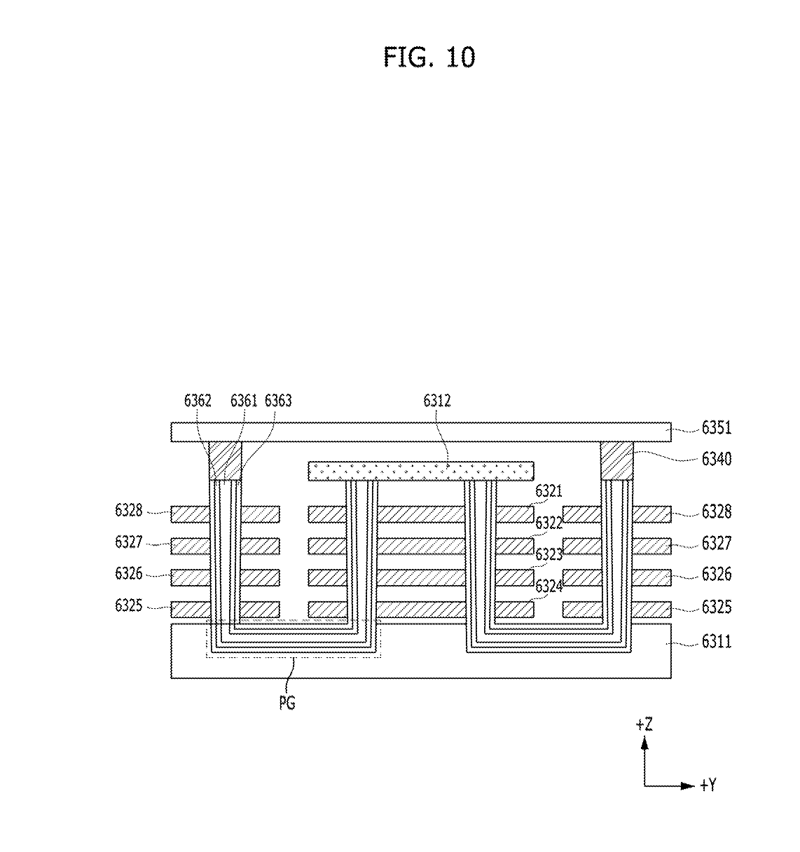

FIG. 9 is a perspective view schematically illustrating the memory device implemented with the 3D nonvolatile memory device, which is different from the first structure described above with reference to FIGS. 5 to 8, and showing a memory block BLKj of the plurality of memory blocks of FIG. 4. FIG. 10 is a cross-sectional view of the memory block BLKj taken along the line VII-VII′ of FIG. 9.

Referring to FIGS. 9 and 10, the memory block BLKj may include structures extending in the first to third directions.

A substrate 6311 may be provided. For example, the substrate 6311 may include a silicon material doped with a first type impurity. For example, the substrate 6311 may include a silicon material doped with a p-type impurity or may be a p-type well, for example, a pocket p-well, and include an n-type well which surrounds the p-type well. While it is assumed in the described embodiment for the sake of convenience that the substrate 6311 is p-type silicon, it is to be noted that the substrate 6311 is not limited to being p-type silicon.

First to fourth conductive materials 6321 to 6324 extending in the x-axis direction and the y-axis direction may be provided over the substrate 6311. The first to fourth conductive materials 6321 to 6324 may be separated by a predetermined distance in the z-axis direction.

Fifth to eighth conductive materials 6325 to 6328 extending in the x-axis direction and the y-axis direction may be provided over the substrate 6311. The fifth to eighth conductive materials 6325 to 6328 may be separated by a predetermined distance in the z-axis direction. The fifth to eighth conductive materials 6325 to 6328 may be separated from the first to fourth conductive materials 6321 to 6324 in the y-axis direction.

A plurality of lower pillars DP may pass through the first to fourth conductive materials 6321 to 6324. Each lower pillar DP may extend in the z-axis direction. Also, a plurality of upper pillars UP may pass through the fifth to eighth conductive materials 6325 to 6328. Each upper pillar UP may extend in the z-axis direction.

Each of the lower and the upper pillars DP and UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower and the upper pillars DP and UP may be coupled electrically through a pipe gate PG. The pipe gate PG may be disposed in the substrate 6311. For instance, the pipe gate PG may include the same material as the material employed for the lower and upper pillars DP and UP.

A doping material 6312 of a second type extending in the x-axis and the y-axis directions may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 extending in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be coupled electrically through contact plugs. The first and second upper conductive materials 6351 and 6352 may serve as first and second bit lines BL1 and BL2, respectively.

The first conductive material 6321 may serve as a source select line SSL, the second conductive material 6322 may serve as a first dummy word line DWL1, and the third and fourth conductive materials 6323 and 6324 may serve as first and second main word lines MWL1 and MWL2, respectively. The fifth and sixth conductive materials 6325 and 6326 may serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP may form a lower string. The upper pillar UP and the fifth to eighth conductive materials 6325 to 6328 adjacent to the upper pillar UP may form an upper string. The lower string and the upper string may be coupled electrically through the pipe gate PG. One end of the lower string may be coupled electrically to the doping material 6312 of the second type which serves as the common source line CSL. One end of the upper string may be coupled electrically to a corresponding bit line through the drain 6340. One lower string and one upper string may form one cell string coupled electrically between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

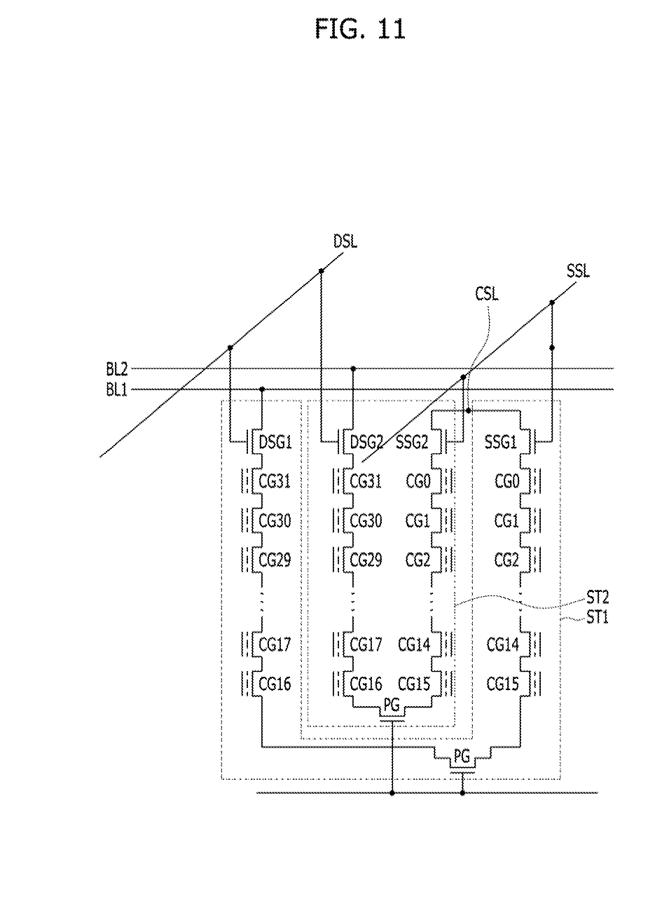

FIG. 11 is a circuit diagram illustrating the equivalent circuit of the memory block BLKj having the second structure as described above with reference to FIGS. 9 and 10. For the sake of convenience, only a first and a second string forming a pair in the memory block BLKj in the second structure are shown.

Referring to FIG. 11, in the memory block BLKj having the second structure among the plurality of blocks of the memory device 150, cell strings, each of which is implemented with one upper string and one lower string coupled electrically through the pipe gate PG as described above with reference to FIGS. 9 and 10, may be provided in such a way as to define a plurality of pairs.

Namely, in the certain memory block BLKj having the second structure, memory cells CG0 to CG31 stacked along a first channel CH1 (not shown), for example, at least one source select gate SSG1 and at least one drain select gate DSG1 may form a first string ST1, and memory cells CG0 to CG31 stacked along a second channel CH2 (not shown), for example, at least one source select gate SSG2 and at least one drain select gate DSG2 may form a second string ST2.

The first and the second strings ST1 and ST2 may be coupled electrically to the same drain select line DSL and the same source select line SSL. The first string ST1 may be coupled electrically to a first bit line BL1, and the second string ST2 may be coupled electrically to a second bit line BL2.

While it is described in FIG. 11 that the first and second strings ST1 and ST2 may be coupled electrically to the same drain select line DSL and the same source select line SSL different layouts may be envisaged. For example, in an embodiment, the first and second strings ST1 and ST2 may be coupled electrically to the same source select line SSL and the same bit line BL, the first string ST1 may be coupled electrically to a first drain select line DSL1 and the second string ST2 may be coupled electrically to a second drain select line DSL2. Further it may be envisaged that the first and second strings ST1 and ST2 may be coupled electrically to the same drain select line DSL and the same bit line BL, the first string ST1 may be coupled electrically to a first source select line SSL1 and the second string ST2 may be coupled electrically a second source select line SSL2.

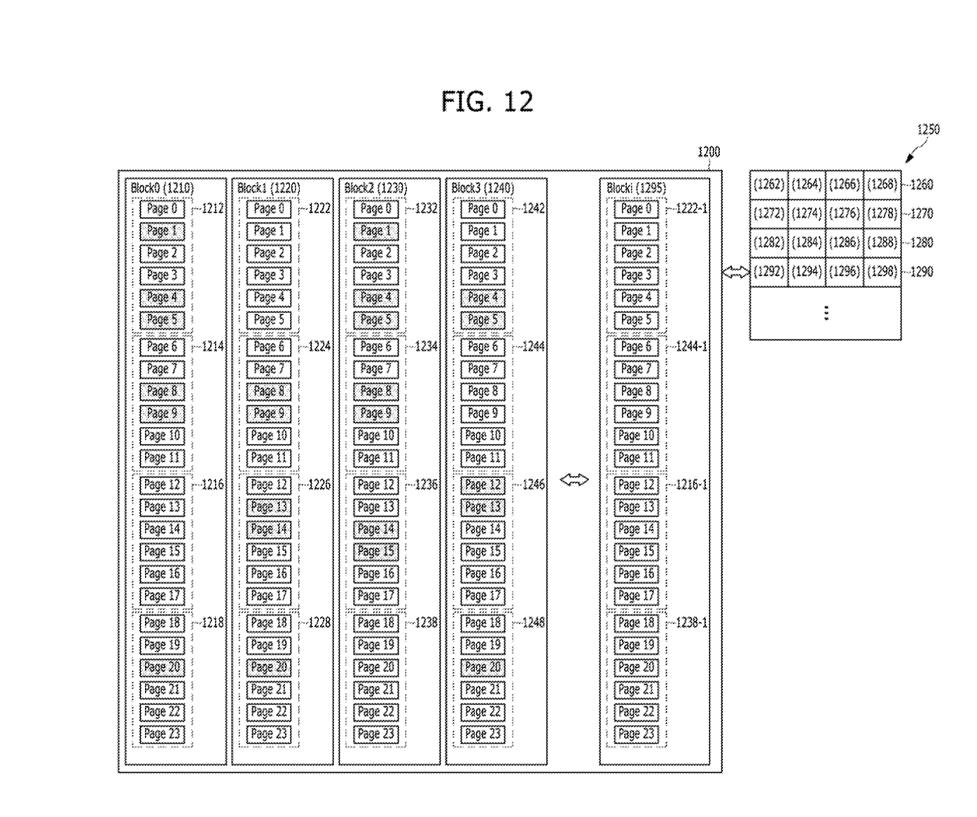

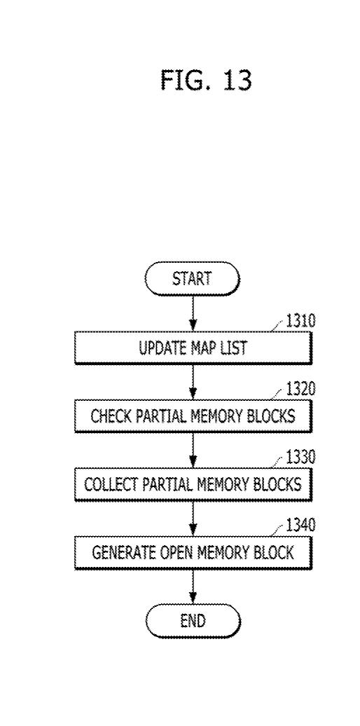

Hereafter, in reference to FIGS. 12 to 13 a data processing operation of a memory system for processing data to a memory device is provided, according to an embodiment of the invention. For the sake of convenience, an example, the data processing operation is described for the case where the memory system programs data to the memory device.

FIG. 12 is a diagram schematically describing an example of a data processing operation of a memory system 110 for processing data to a memory device 1200, according to an embodiment of the present invention.

Hereafter, for convenience of description, a data processing operation in the following embodiment will be taken as an example: the memory system 110 illustrated in FIG. 1 may store write data corresponding to a write command provided from the host 102 into a buffer/cache included in the memory 144 of the controller 130, then may write (i.e. may program) the data stored in the buffer/cache to a plurality of memory blocks included in the memory device 150. After that, the memory system 110 may update the data programmed in the memory device 150 in response to current write data corresponding to a current write command for the plurality of memory blocks of the memory device 150 storing the previous data.

In the present embodiment, write data corresponding to a write command provided from the host 102 may be programmed and stored in the memory blocks of the memory device 150. For example, each of the memory blocks may include a plurality of pages, and the write data may be programmed and stored in the pages of the memory block. At this time, when a current write command for the pages of one of the memory blocks storing previously programmed data is provided from the host 102, the data stored in the pages may be updated by programming current write data corresponding to the current write command to pages of another memory block. Thus, the previously programmed data stored in the pages of the memory blocks may become invalid data, and the pages storing the previously programmed data may become invalid pages.

When the pages of the memory blocks of the memory device 150 become invalid, the garbage collection may be performed in order to maximize the use efficiency of the memory device 150. For example, the memory system 110 may collect the whole or segments of closed memory blocks including invalid pages among the memory blocks of the memory device 150 and generate an empty memory block by performing the garbage collection on the memory blocks of the memory device 150. Hereafter, the operation of generating an empty memory block for the segment of the memory blocks will be further described as an example.

Furthermore, for convenience of description, the case in which the data processing operation of the memory system 110 is performed by the controller 130 will be taken as an example. As described above, however, the processor 134 included in the controller 130 may perform a data processing operation through the FTL, for example.

For example, the controller 130 may program write data corresponding to a write command received from the host 102 to a first page of a first memory block. After that, when a new write command for the first page of the first memory block storing previously programmed data is received from the host 102, the controller 130 may program new write data corresponding to the new write command in a second page of the first memory block or a first page of a second memory block. At this time, the controller 130 may process the previously programmed data stored in the first page of the first memory block into the invalid data. Thus, the first page of the first memory block may be set to be an invalid page.

The controller 130 may generate an empty memory block available for storing data by collecting the page zones of the memory blocks including invalid pages from closed memory blocks which are full of programmed data among the memory blocks of the memory device 150.

For convenience of description, the operation of processing data and memory blocks in the following case will be described in more detail: the controller 130 may update the data stored in the closed memory blocks full of programmed data among the memory blocks of the memory device 150 in response to a new write command for the closed memory blocks by programming a new write data corresponding to the new write command to another memory block and get the previously programmed data and the corresponding page designated as invalid. The operation of generating an empty memory block may be performed by collecting the whole or segments of closed memory blocks including invalid pages before performing the garbage collection to the closed memory blocks of the memory device 150.

Referring to FIG. 12, the controller 130 may program write data to a plurality of memory blocks included in a memory device 1200, for example, a memory block 0 (1210), a memory block 1 (1220), a memory block 2 (1230), and a memory block 3 (1240) in response to a write command provided from the host 102.

It is assumed that the memory blocks 0 to 3 (1210 to 1240) are closed memory blocks, i.e., full of programmed data. The controller 130 may program and store write data corresponding to a write command provided from the host 102 into the pages of the memory blocks 0 to 3 (1210 to 1240) of the memory device 1200. The controller 130 may generate map information based on the data stored in the pages of the memory blocks 0 to 3 (1210 to 1240), for example, L2P information containing logical address/physical address information of the data having logical page numbers and P2L information containing logical page number information of the data stored in the pages of the memory blocks 0 to 3 (1210 to 1240), and then store the generated L2P and P2L information. The L2P information may include L2P tables containing physical map information on the data stored in the pages of all the memory blocks of the memory device 1200. The P2L information may include P2L tables containing logical information on the data stored in the pages of all the memory blocks of the memory device 1200.

As described above, the plurality of memory blocks included in the memory device 150 may include a plurality of pages. Each of the memory blocks may include a plurality of page zones or segments of the memory block each including a preset number of pages. In the present embodiment, during the update of the closed memory blocks of the memory device 150, the controller 130 may check invalid pages and valid pages of the page zones of the closed memory blocks based on the result of the update, and update a valid page existence information indicating whether each page zone of the closed memory blocks is full of invalid pages. The valid page existence information may be stored in a map list.

In the present embodiment, before performing the garbage collection on the closed memory blocks of the memory device 150, the controller 130 may generate an empty memory block by collecting the whole or segments of closed memory blocks which are full of the invalid pages based on the map list. The controller 130 may generate another empty memory block by performing the garbage collection on the whole or segments of closed memory blocks including valid pages.

For example, the valid page existence information on each of the page zones included in each of the closed memory blocks may be included in the form of bitmap, clean map, or clean block bitmap in the map list. According to the valid page existence information contained in the map list, the controller 130 may identify a page zone that is full of invalid pages and thus generate the empty memory block by collecting the whole or segments of closed memory blocks which are full of invalid pages.

The controller 130 may store the map list in the memory 144 of the controller 130 or in an arbitrary memory block among the memory blocks of the memory device 150. The memory block having the map list stored therein may store storage information of the read/write data indicating whether valid pages exist in the memory device 150, for example, map information, address information, page information, Logical to Physical (L2P) Information, Physical to Logical (P2L) Information, or meta data including such information.

Each of the memory blocks included in the memory device 150, for example, the memory blocks 0 to 3 (1210 to 1240) of the memory device 1200 may include a plurality of page zones or segments each including a preset number of pages, for example, 6 pages as shown in the example of FIG. 12. The memory blocks 0 to 3 (1210 to 1240) of the memory device 1200 may form a super block.

For example, the memory block 0 (1210) of the memory device 1200 may include a page zone 0 (1212), a page zone 1 (1214), a page zone 2 (1216), and a page zone 3 (1218), each of which may include 6 pages. The memory block 1 (1220) of the memory device 1200 may include a page zone 0 (1222), a page zone 1 (1224), a page zone 2 (1226), and a page zone 3 (1228), each of which may include 6 pages. The memory block 2 (1230) of the memory device 1200 may include a page zone 0 (1232), a page zone 1 (1234), a page zone 2 (1236), and a page zone 3 (1238), each of which may include 6 pages. The memory block 3 (1240) of the memory device 1200 may include a page zone 0 (1242), a page zone 1 (1244), a page zone 2 (1246), and a page zone 3 (1248), each of which may include 6 pages.

During the update of the closed memory blocks, for example, the memory blocks 0 to 3 (1210 to 1240) of the memory device 1200, the controller 130 may check invalid pages and valid pages of the page zones of the closed memory blocks 0 to 3 (1210 to 1240) based on the result of the update, and update the valid page existence information of the map list 1250. The map list 1250 may store the valid page existence information of the closed memory blocks 0 to 3 (1210 to 1240) in the corresponding rows thereof. For example, the map list 1250 may store the valid page existence information on the closed memory blocks 0 to 3 (1210 to 1240) in first to fourth rows 1260 to 1290, respectively.

The valid page existence information of the closed memory blocks 0 to 3 (1210 to 1240) may be stored in predetermined bit regions of the respective rows 1260 to 1290 of the map list 1250. The predetermined bit regions of the rows 1260 to 1290 of the map list 1250 may correspond to the page zones of the respective closed memory blocks 0 to 3 (1210 to 1240). Thus, the valid page existence information on the page zones of the closed memory blocks 0 to 3 (1210 to 1240) may be stored in the corresponding bit regions of the map list 1250.

For example, the valid page existence information on the page zones 0 to 3 (1212 to 1218) of the memory block 0 (1210) may be stored in first to fourth bit regions 1262 to 1268 of the first row 1260 in the map list 1250, respectively. The valid page existence information on the page zones 0 to 3 (1222 to 1228) of the memory block 1 (1220) may be stored in first to fourth bit regions 1272 to 1278 of the second row 1270 in the map list 1250, respectively. The valid page existence information on the page zones 0 to 3 (1232 to 1238) of the memory block 2 (1230) may be stored in first to fourth bit regions 1282 to 1288 of the third row 1280 in the map list 1250, respectively. The valid page existence information on the page zones 0 to 3 (1242 to 1248) of the memory block 3 (1240) may be stored in first to fourth bit regions 1292 to 1298 of the fourth row 1290 in the map list 1250, respectively.

One or more bits (e.g., 6 bits corresponding to 6 pages included in the page zone or the segment of the closed memory block) for each valid page existence information of the page zones or the segments of the closed memory blocks 0 to 3 (1210 to 1240) may be allocated to each bit region of the map list 1250. In the case where a single bit for each valid page existence information of the page zones or the segments is allocated to each bit region of the map list 1250, during the update of the closed memory blocks 0 to 3 (1210 to 1240), the controller 130 may set one or more of the bit regions of the map list 1250 to ‘1’ to indicate that corresponding page zones are full of invalid pages.

Hereafter, the process in which an empty memory block is generated through the data processing operation will be described, according to an embodiment of the present invention.

When a write command for the closed memory blocks 0 to 3 (1210 to 1240) is received from the host 102, the controller 130 may update and program write data corresponding to the write command to pages of a new arbitrary memory block, instead of the closed memory blocks 0 to 3 (1210 to 1240). As the write data are updated and programmed to the pages of the new arbitrary memory block, the L2P information and the P2L information may be updated. According to the update of the closed memory blocks 0 to 3 (1210 to 1240), the valid page existence information for the page zones of the closed memory blocks 0 to 3 (1210 to 1240) may be updated in the map list 1250.

For example, when a write command for the pages other than the pages 1, 4, 5, 8, 9 and 20 of the closed memory block 0 (1210) is received from the host 102, the controller 130 may program data corresponding to the write command to an arbitrary memory block of the memory device 150. Thus, at that time, the pages 1, 4, 5, 8, 9 and 20 of the memory block 0 (1210) may remain valid pages indicated by the shaded boxes. The remaining pages of the memory block 0 (1210) become invalid pages indicated by the non-shaded boxes. When the page zone 2 (1216) is full of invalid pages among the plural page zones 0 to 3 (1212 to 1218) of the closed memory block 0 (1210), the controller 130 may set the third bit region 1266 of the first row 1260 of the map list 1250 to ‘1’ for indicating that the page zone 2 (1216) of the closed memory block 0 (1210) is full of invalid pages.

In a similar way, the controller 130 may set bit regions of the map list 1250 to ‘1’ for indicating that corresponding page zones or the segments of the respective blocks 1210 to 1240 are full of invalid pages. FIG. 12 exemplifies that the controller 130 should set the first bit region 1272 of the second row 1270 of the map list 1250 to ‘1’ for indicating that the page zone 0 (1222) of the closed memory block 1 (1220) is full of invalid pages; should set the fourth bit region 1288 of the third row 1280 of the map list 1250 to ‘1’ for indicating that the page zone 3 (1238) of the closed memory block 2 (1230) is full of invalid pages; and sets the second bit region 1294 of the fourth row 1290 of the map list 1250 to ‘1’ for indicating that the page zone 2 (1244) of the closed memory block 3 (1240) is full of invalid pages.

When invalid pages are included in the memory blocks of the memory device 1200, the controller 130 may perform the garbage collection operation to the memory blocks of the memory device 130 which contain invalid pages.

According to an embodiment of the present invention, before initiation of the garbage collection operation, the controller 130 may generate an empty memory block in the memory device 1200 based on the valid page existence information on the page zones in the closed memory blocks of the memory device 1200. In other words, the controller 130 may check and collect the page zones of the closed memory blocks which are full of invalid pages through the map list 1250, for forming an empty “virtual” memory block before performing a garbage collection operation for reclaiming invalid pages of page zones having both valid and invalid pages of closed memory blocks. After that, the controller 130 may also generate another empty memory block by performing a garbage collection to reclaim invalid pages on page zones of the closed memory blocks which include both valid pages and invalid pages. In this manner, use of a garbage collection operation may be reduced substantially and the use efficiency of the memory device 1200 may be increased.

For example, the controller 130 may check the page zones or the segments which are full of invalid pages in the closed memory blocks 0 to 3 (1210 to 1240) through the valid page existence information on the closed memory blocks 0 to 3 (1210 to 1240) stored in the map list 1250. For example, the controller 130 may determine that the page zone 2 (1216) of the memory block 0 (1210), the page zone 0 (1222) of the memory block 1 (1220), the page zone 3 (1238) of the memory block 2 (1230), and the page zone 1 (1244) of the memory block 3 (1240) are full of invalid pages based on the third bit region 1266 of the first row, the first bit region 1272 of the second row, the fourth bit region 1288 of the third row, and the second bit region 1294 of the fourth row in the map list 1250, respectively.

The controller 130 may generate an empty memory block i (1295) by collecting the page zone 1216 of the memory block 0 (1210), the page zone 0 (1222) of the memory block 1 (1220), the page zone 3 (1238) of the memory block 2 (1230), and the page zone 1 (1244) of the memory block 3 (1240), which are determined to be full of invalid pages. Therefore, the empty memory block i (1295) may include a page zones 0 to 3 (1222-1 to 1238-1), which correspond to page zone 0 (1222) of the memory block 1 (1220), the page zone 1 (1244) of the memory block 3 (1240), the page zone 1216 of the memory block 0 (1210), and the page zone 3 (1238) of the memory block 2 (1230), respectively. Henceforth, the empty memory block i (1295) may store data in response to the write command provided from the host 102. Further, the controller 130 may generate another empty memory block by performing the garbage collection on an entire memory block or a page zone of a memory block other than the page zone 1216 of the memory block 0 (1210), the page zone 0 (1222) of the memory block 1 (1220), the page zone 3 (1238) of the memory block 2 (1230), and the page zone 1 (1244) of the memory block 3 (1240), which are determined to be full of invalid pages.

FIG. 13 is a flowchart of a data processing operation on the memory system 110, according to an embodiment of the present invention.

It is assumed that the memory blocks 0 to 3 (1210 to 1240) of the memory device 1200 are closed memory blocks, i.e., they are full of programmed data.

Referring to FIGS. 12 and 13, when a write command for the closed memory blocks 0 to 3 (1210 to 1240) of the memory device 1200 is received from the host, the memory system 110 may update the closed memory blocks 0 to 3 (1210 to 1240) by programming data corresponding to the write command into an arbitrary memory block among the memory blocks of the memory device 1200, and then update the valid page existence information of the map list 1250 based on the result of the update of the closed memory blocks 0 to 3 (1210 to 1240), at step 1310. As exemplified in FIG. 12, the pages 1, 4, 5, 8, 9 and 20 of the memory block 0 (1210) may at that time remain valid pages and be designated as valid pages, whereas the other pages of the memory block 0 (1210) may become invalid pages. For example, when the page zone 2 (1216) is full of invalid pages among the plural page zones 0 to 3 (1212 to 1218) of the closed memory block 0 (1210), the controller 130 may set the third bit region 1266 of the first row 1260 of the map list 1250 to ‘1’ for indicating that the page zone 2 (1216) of the closed memory block 0 (1210) is full of invalid pages.

At step 1320, the memory system 110 may check the page zones of the closed memory blocks 0 to 3 (1210 to 1240) which are full of invalid pages based on the map list 1250. As exemplified in FIG. 12, the controller 130 may determine that the page zone 2 (1216) of the memory block 0 (1210), the page zone 0 (1222) of the memory block 1 (1220), the page zone 3 (1238) of the memory block 2 (1230), and the page zone 1 (1244) of the memory block 3 (1240) are full of invalid pages based on the third bit region 1266 of the first row, the first bit region 1272 of the second row, the fourth bit region 1288 of the third row, and the second bit region 1294 of the fourth row in the map list 1250, respectively.

At step 1330, the memory system 110 may collect the page zones of the memory blocks which are full of invalid pages from the different the memory blocks. As exemplified in FIG. 12, the controller 130 may collect the page zone 1216 of the memory block 0 (1210), the page zone 0 (1222) of the memory block 1 (1220), the page zone 3 (1238) of the memory block 2 (1230), and the page zone 1 (1244) of the memory block 3 (1240), which are determined to be full of invalid pages. At step 1340, the memory system 110 may generate an empty memory block using the collected page zones or the segments of the memory blocks full of invalid pages. As exemplified in FIG. 12, the controller 130 may generate an empty memory block i (1295) by collecting the page zone 1216 of the memory block 0 (1210), the page zone 0 (1222) of the memory block 1 (1220), the page zone 3 (1238) of the memory block 2 (1230), and the page zone 1 (1244) of the memory block 3 (1240), which are determined to be full of invalid pages. Therefore, the empty memory block i (1295) may include page zones 0 to 3 (1222-1 to 1238-1), which respectively correspond to the page zone 0 (1222) of the memory block 1 (1220), the page zone 1 (1244) of the memory block 3 (1240), the page zone 1216 of the memory block 0 (1210), and the page zone 3 (1238) of the memory block 2 (1230). Henceforth, the empty memory block i (1295) may store data in response to the write command provided from the host 102.

According to embodiments of the present invention, the memory system and the operating method thereof may reduce the utilization of a garbage operation. This in turn may improve the use efficiency of the memory device, thereby more rapidly and more stably processing data. The present invention may also reduce the performance degradation of the memory system.

Although various embodiments have been described for illustrative purposes, it will be apparent to those skilled in the art that various changes and modifications may be made without departing from the spirit and or scope of the invention as defined in the following claims.

What is claimed is:

1. A memory system comprising:
a plurality of memory blocks each including a plurality of page zones each page zone including a plurality of pages suitable for storing data; and
a controller suitable for updating one or more closed memory blocks, by storing data into another memory block among the memory blocks in response to a write command for the one or more closed memory blocks, and updating a map list indicating one or more invalid page zones each of which contains only invalid pages in the closed memory blocks, as a result of the updating of the closed memory blocks.

2. The memory system of claim 1, wherein the map list comprises a plurality of bit regions corresponding to the page zones of the memory blocks, respectively.

3. The memory system of claim 2, wherein the controller sets the bit regions to a value representing the invalid segment as the result of the updating of the closed memory blocks.

4. The memory system of claim 3, wherein the controller further generates an empty memory block by detecting and collecting the invalid page zones.

5. The memory system of claim 4, wherein the controller generates the empty memory block with the invalid page zones based on the set value of the bit regions.

6. The memory system of claim 4, wherein the controller further performs an garbage collection to the other page zones other than the invalid page zones in the closed memory blocks.

7. The memory system of claim 1, wherein the map list is in the form of bitmap, clean map, or clean block bitmap.

8. An operating method of a memory system including a plurality of memory blocks each including a plurality of page zones each including a plurality of pages suitable for storing data, the operating method comprising:
updating one or more closed memory blocks, which are full of programmed data, by storing data into another memory block among the memory blocks in response to a write command for the closed memory blocks; and
updating a map list indicating one or more invalid page zones, each of which is full of invalid pages in the closed memory blocks, as a result of the updating of the closed memory blocks.

9. The operating method of claim 8, wherein the map list comprises a plurality of bit regions corresponding to the page zones of the memory blocks, respectively.

10. The operating method of claim 9, wherein the updating of the map list includes setting the bit regions to a value representing the invalid segment as the result of the updating of the closed memory blocks.

11. The operating method of claim 10, further comprising generating an empty memory block with the invalid page zones.

12. The operating method of claim 11, the generating of the empty memory block is performed on the basis of the set value of the bit regions.

13. The operating method of claim 11, further comprising performing a garbage collection to the other page zones other than the invalid page zones in the closed memory blocks.

14. The operating method of claim 8, wherein the map list is in the form of bitmap, clean map, or clean block bitmap.

15. A memory system comprising:
a plurality of memory blocks each including a plurality of page zones each page zone including a plurality of pages suitable for storing data; and
a controller suitable for detecting page zones having only invalid pages from a plurality of page zones of a plurality of closed memory blocks, and for collecting the detected invalid page zones to generate a first empty memory block before performing a garbage collection operation for reclaiming invalid pages of page zones having both valid and invalid pages.

16. The memory system of claim 15, wherein the controller is suitable for performing a garbage collection operation to create one or more additional empty memory blocks on either an entire memory block comprising only page zones having both valid and invalid pages or on a page zone having both valid and invalid pages, after the generation of the first empty memory block.
